(19) United States
(12) Patent Application Publication
(10) Pub. No.: US 2024/0253230 A1
(43) Pub. Date: Aug. 1, 2024

(54) Method For Generating Trajectory Of Industrial Robot

(71) Applicant: MakinaRocks Co., Ltd., Seoul (KR)

(72) Inventors: Jeyeol LEE, Seoul (KR); Goncalves Rocha YURI, Seoul (KR); Yu Jeong JEONG, Seoul (KR)

(73) Assignee: MakinaRocks Co., Ltd., Seoul (KR)

(21) Appl. No.: 18/427,253

(22) Filed: Jan. 30, 2024

(30) Foreign Application Priority Data
Jan. 30, 2023 (KR) 10-2023-0011504

(51) Int. Cl. B25J 9/16

(52) U.S. Cl. CPC B25J 9/1666

(57) ABSTRACT

Disclosed is a method performed by a computing device to generate a working trajectory of an industrial robot. Particularly, the computing device according to the present disclosure identifies a plurality of working points for one or more industrial robots; identifies a collision point based on a trajectory between the plurality of working points; modifies the trajectory between the working points based on information of the collision point; and generates a working trajectory of the industrial robot based on the modified trajectory between the working points.

### CROSS-REFERENCE TO RELATED APPLICATIONS

This application claims priority to and the benefit of Korean Patent Application No. 10-2023-0011504 filed in the Korean Intellectual Property Office on Jan. 30, 2023, the entire contents of which are incorporated herein by reference.

### TECHNICAL FIELD

The present disclosure relates to a method of generating a working trajectory for an industrial robot, and more particularly to a method of identifying a working point for one or more industrial robots to work on, identifying collision points based on a trajectory between the working points, and generating a working trajectory that avoids the collision.

### BACKGROUND ART

The development of industrial robots has led to a significant amount of automation in the production process of manufactured goods, such as vehicles. In order for industrial robots to be applied in the real world, it is usually necessary to test a robot program in a simulation and then perform Off-Line Programming (OLP) to operate the actual robot, and the overall process thereof includes, as a part, a planning process to generate a trajectory through which a specific robot routes to and from working points assigned to the specific robot.

When a trajectory between the working points is generated, conventionally used Rapidly-exploring random tree (RRT) algorithms have the advantage of avoiding obstacles and computing a trajectory from a start point to a destination point relatively quickly. However, the sampling-based planning method, such as RRT, may generate samples that a robot passes through at places close to obstacles. In this case, each sample does not collide with an obstacle, but there may occur a case where a robot collides with an obstacle while moving between samples. Traditionally, methods, such as Continuous Collision Detection (CCD), have attempted to solve these issues, but such a method is slow to detect collisions, resulting in longer overall trajectory planning times.

Therefore, there is a demand in the industry for a method of generating an accurate working trajectory that allows a robot to move fast and prevents a robot from colliding with obstacles.

### SUMMARY OF THE INVENTION

The present disclosure has been conceived to provide a method of identifying working points for one or more industrial robots to work on, identifying a collision point based on a trajectory between the working points, and generating a working trajectory that avoids the collision.

On the other hand, the technical problem to be achieved by the present disclosure is not limited to the technical problem mentioned above, and various technical problems may be included within the range obvious to those skilled in the art from the content to be described below.

An exemplary embodiment of the present disclosure provides a method performed by a computing device to generate a working trajectory of an industrial robot, the method including: identifying a plurality of working points for one or more industrial robots; identifying a collision point based on a trajectory between the plurality of working points; modifying the trajectory between the working points based on information of the collision point; and generating a working trajectory of the industrial robot based on the modified trajectory between the working points.

In the exemplary embodiment, the modifying of the trajectory between the working points based on the information of the collision point may include: generating a waypoint based on the information of the collision point; determining a movement direction based on the information of the collision point; moving the waypoint based on the movement direction; and modifying the trajectory between the working points to pass through the waypoint.

In the exemplary embodiment, the movement direction may include a direction of a normal vector of the collision point.

In the exemplary embodiment, the movement direction may include a direction of a mean normal vector computed based on a penetration depth of the collision point.

In the exemplary embodiment, the movement direction may include a direction of one of: a first normal vector computed based on a penetration depth of the collision point; a second normal vector computed based on information of a plurality of collision points and information of a mesh of the plurality of collision points, when the collision points are plural; or a third normal vector computed based on the first normal vector and the second normal vector.

In the exemplary embodiment, the moving of the waypoint based on the movement direction may include moving a location of the waypoint within a threshold in the movement direction until the collision point disappears.

In the exemplary embodiment, the modifying of the trajectory between the working points based on the information of the collision point may include: inputting information of the collision point and information of the working point into a trajectory modification model, which is a reinforcement learning model; and modifying the trajectory between the working points by using the trajectory modification model.

In the exemplary embodiment, the trajectory modification model may be pre-trained based on a reward computed based on a presence of a collision point, a length of a total working trajectory, and a total working time.

Another exemplary embodiment of the present disclosure provides a computer program for performing operations for generating a working trajectory of an industrial robot, the operations including: an operation of identifying a plurality of working points for one or more industrial robots; an operation of identifying a collision point based on a trajectory between adjacent working points among the plurality of working points; an operation of modifying the trajectory between the working points based on the information of the collision point; and an operation of generating a working trajectory of the industrial robot based on the modified trajectory between the working points.

Still another exemplary embodiment of the present disclosure provides a computer program stored in a computer-readable storage medium, the computer program including instructions to cause a computing device to perform operations for generating a working trajectory of an industrial robot, the operations including: an operation of identifying a plurality of working points for one or more industrial robots; an operation of identifying a collision point based on a trajectory between the plurality of working points; an operation of modifying the trajectory between the working points based on the information of the collision point; and an operation of generating a working trajectory of the industrial robot based on the modified trajectory between the working points.

Yet another exemplary embodiment of the present disclosure provides a computing device including: a processor including one or more cores; a network unit; and a memory, in which the processor is configured to: identify a plurality of working points for one or more industrial robots, identify a collision point based on a trajectory between adjacent working points among the plurality of working points, modify the trajectory between the working points based on information of the collision point, and generate a working trajectory of the industrial robot based on the modified trajectory between the working points.

The present disclosure may provide a working trajectory for an industrial robot. For example, the present disclosure may identify working points for one or more industrial robots to work on, identify a collision point based on a trajectory between the working points, and generate a working trajectory that avoids the collision.

### BRIEF DESCRIPTION OF THE DRAWINGS

FIG. 1 is a block diagram of a computing device for generating a working trajectory for an industrial robot according to an exemplary embodiment of the present disclosure.

FIG. 2 is a schematic diagram illustrating a network function according to the exemplary embodiment of the present disclosure.

FIG. 3 is a flowchart illustrating a process for generating a working trajectory for an industrial robot according to an exemplary embodiment of the present disclosure.

FIG. 4 is a conceptual diagram illustrating a normal vector according to the exemplary embodiment of the present disclosure.

FIG. 5 is a conceptual diagram illustrating an example of a collision according to the exemplary embodiment of the present disclosure.

FIG. 6 is a conceptual diagram illustrating an example of a normal vector according to the exemplary embodiment of the present disclosure.

FIG. 7 is a conceptual diagram illustrating a reinforcement learning model according to the exemplary embodiment of the present disclosure.

FIG. 8 is a simple and general schematic diagram for an example of a computing environment in which exemplary embodiments of the present disclosure are implementable.

### DETAILED DESCRIPTION

The present disclosure discloses a method of identifying a working point for one or more industrial robots to work on, identifying collision points based on a trajectory between the working points, and generating a working trajectory that avoids the collision.

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components.

One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally In terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, a network function and an artificial neural network and a neural network may be interchangeably used.

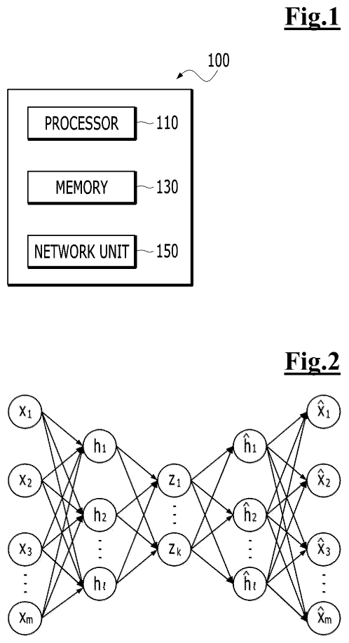

FIG. 1 is a block diagram of a computing device for generating a working trajectory for an industrial robot according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for training the neural network. At least one of the CPU, GPGPU, and TPU of the processor 110 may process training of a network function. For example, both the CPU and the GPGPU may process the training of the network function and data classification using the network function. Further, in an exemplary embodiment of the present disclosure, processors of a plurality of computing devices may be used together to process the training of the network function and the data classification using the network function. Further, the computer program executed in the computing device according to an exemplary embodiment of the present disclosure may be a CPU, GPGPU, or TPU executable program.

The processor 110 may identify a plurality of working points for a single industrial robot. For example, in a welding process for vehicle assembly, when multiple industrial robots are operated at one station, a working point may refer to a welding point. In this case, some of the total welding points may be distributed to one industrial robot by another automated process or human's manipulation, and the processor 110 may identify the welding points distributed to each industrial robot.

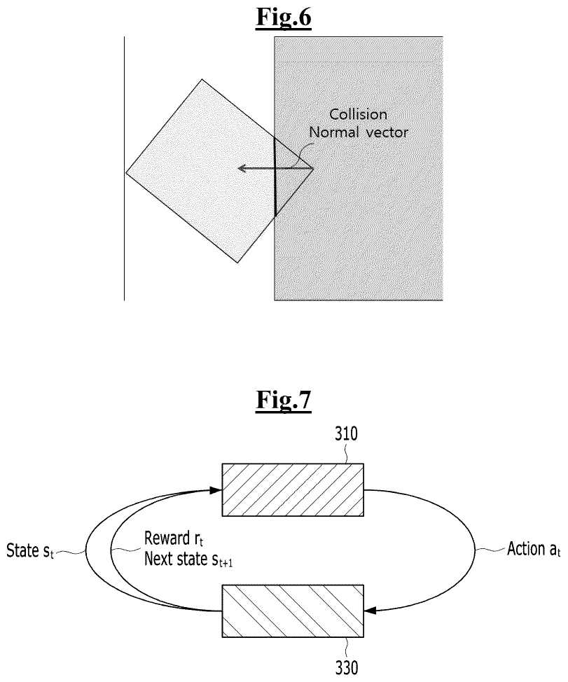

The processor 110 may generate a trajectory between working points. It has been described above that methods, such as RRT, have been used in the art for generating a trajectory along which an industrial robot moves between working point A and working point B. However, in an algorithm, such as RRT, that detects collisions in the unit of a sample point and generates a trajectory having no collision, it may occur that each sample has no collision, but the trajectory connecting the respective samples has a collision. An example situation where a collision occurs on a trajectory between working points as described above is illustrated in FIG. 5. Such collisions may be prevented by using technologies, such as Continuous Collision Detection (CCD), but since the generation of a work trajectory by using CCD is slow, the present disclosure has the effect of generating a work trajectory at a faster speed compared to CCD by quickly generating a trajectory between working points in the unit of sample point, such as RRT, and then modifying the generated trajectory to prevent collisions from occurring.

In the trajectory between the plurality of working points, the processor 110 may identify a point where collision occurs, and modify the trajectory between the working points to prevent collisions from occurring. In the present disclosure, a collision point may refer to an area where components, including end-effectors, of an industrial robot overlap a work target in the same space in a working simulation process of the industrial robot. When a collision point is detected in the simulation, it may be necessary to modify the trajectory of the industrial robot to avoid collision, because when the trajectory is not corrected, the robot or an obstacle may be damaged when the robot actually performs work.

In the present disclosure, the method of modifying, by the processor 110, a trajectory between working points may be a method of generating a waypoint on a movement trajectory between working points based on information about a collision point, and modifying a trajectory by moving a location of the waypoint to prevent a collision from occurring. For example, when an end effector of an industrial robot moves between working point A and working point B and a collision occurs, the processor 110 may designate the point where the collision occurs as point X, move the location of point X to a location where the collision does not occur, and modify the entire trajectory so that the end effector moves from A to X and from X to B.

The processor 110 may repeat an operation of moving the location of the waypoint within a threshold in a movement direction until the collision point disappears. For example, the processor 110 may determine a movement direction of the waypoint when a collision occurs, and detect whether a collision occurs after moving the waypoint 0.001 m in the movement direction. When a collision still occurs, the processor may move the waypoint another 0.001 m in the movement direction and repeat the process of detecting whether a collision occurs. This process may be repeated as long as a movement distance of the waypoint is within a threshold. That is, when the predetermined threshold is 0.03 m, the processor 110 may move the waypoint 0.001 m until the movement distance of the waypoint is 0.03 m and then identify whether a collision occurs, and when a collision still occurs after moving the waypoint 0.03 m, the processor 110 may not move the waypoint further, but instead identify a trajectory between the next working points and work on modifying the corresponding trajectory.

In this case, multiple collision points may occur for a single trajectory between working points, in which case multiple waypoints may be generated, and the processor 110 may modify the trajectory between the working points so that the end effector of the robot traverses all of the generated waypoints.

Based on the modified trajectory between the working points, the processor 110 may generate a work trajectory for the industrial robot by connecting the trajectories between the working points. The overall work trajectory of the industrial robot may be generated by using a method, such as a Probabilistic RoadMap (PRM), and the trajectories between the respective working point in the entire trajectory using the PRM may be modified to avoid collisions by using the methods of the present disclosure. However, the method of generating the entire work trajectory based on the trajectories between working points is not limited to the above example, and a method of generating a trajectory through a reinforcement learning model, and the like may be used without limitation.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to an exemplary embodiment of the present disclosure may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network unit 150 presented in the present disclosure may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

In this disclosure, the network unit 150 can use a wireless communication system of any form.

The techniques described in the present disclosure may also be used in other networks mentioned above.

FIG. 2 is a conceptual view illustrating a neural network according to an exemplary embodiment of the present disclosure.

Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be trained in at least one scheme of supervised learning, unsupervised learning, semi supervised learning, or reinforcement learning. The learning of the neural network may be a process in which the neural network applies knowledge for performing a specific operation to the neural network.

The neural network may be trained in a direction to minimize errors of an output. The training of the neural network is a process of repeatedly inputting training data into the neural network and calculating the output of the neural network for the training data and the error of a target and back-propagating the errors of the neural network from the output layer of the neural network toward the input layer in a direction to reduce the errors to update the weight of each node of the neural network. In the case of the supervised learning, the training data labeled with a correct answer is used for each training data (i.e., the labeled training data) and in the case of the unsupervised learning, the correct answer may not be labeled in each training data. That is, for example, the training data in the case of the supervised learning related to the data classification may be data in which category is labeled in each training data. The labeled training data is input to the neural network, and the error may be calculated by comparing the output (category) of the neural network with the label of the training data. As another example, in the case of the unsupervised learning related to the data classification, the training data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a training cycle (epoch). The learning rate may be applied differently according to the number of repetition times of the training cycle of the neural network. For example, in an initial stage of the training of the neural network, the neural network ensures a certain level of performance quickly by using a high learning rate, thereby increasing efficiency and uses a low learning rate in a latter stage of the training, thereby increasing accuracy.

In training of the neural network, the training data may be generally a subset of actual data (i.e., data to be processed using the trained neural network), and as a result, there may be a training cycle in which errors for the training data decrease, but the errors for the actual data increase. Overfitting is a phenomenon in which the errors for the actual data increase due to excessive training of the training data. For example, a phenomenon in which the neural network that trains a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the training data, regularization, dropout of omitting a part of the node of the network in the process of training, utilization of a batch normalization layer, etc., may be applied.

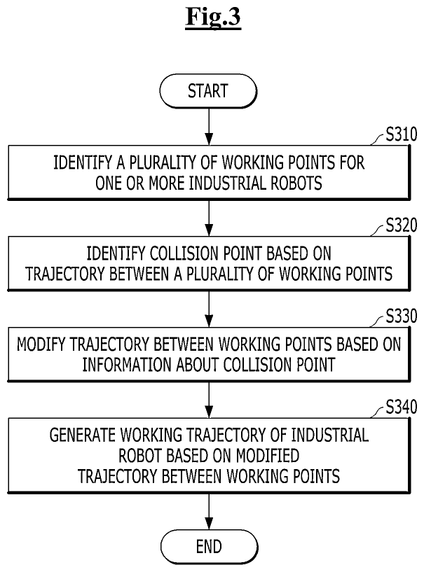

FIG. 3 is a flowchart illustrating a process for generating a working trajectory for an industrial robot according to an exemplary embodiment of the present disclosure.

Referring to FIG. 3, a process for generating a work trajectory of an industrial robot of the present disclosure may include identifying a plurality of working points for one or more industrial robots (S310), identifying a collision point based on a trajectory between the plurality of working points (S320), modifying a trajectory between the working points based on information about the collision point (S330), and generating a work trajectory of the industrial robot based on the modified trajectory between the working points (S340).

In operation S310, the processor 110 may identify a plurality of working points for the one or more industrial robots. A specific process for identifying the working points has been described above with reference to FIG. 1.

In operation S320, the processor 110 may identify a collision point based on a trajectory between the plurality of working points. A specific process for identifying a collision point has been described above with reference to FIG. 1.

In operation S330, the processor 110 may modify the trajectory between the working points based on the information about the collision point. In the present disclosure, the method of modifying, by the processor 110, a trajectory between working points may be a method of generating a waypoint on a movement trajectory between working points based on information about a collision point, and modifying a trajectory by moving a location of the waypoint to prevent a collision from occurring. For example, when an end effector of an industrial robot moves between working point A and working point B and a collision occurs, the processor 110 may designate the point where the collision occurs as point X, move the location of point X to a location where the collision does not occur, and modify the entire trajectory so that the end effector moves from A to X and from X to B.

In the present disclosure, a movement direction of the waypoint may mean the direction of the normal vector of the collision point. In the present disclosure, a normal vector of a collision point may mean a normal vector of a mesh of an obstacle including a collision point. In a non-three-dimensional plane, a conceptual illustration of a normal vector of a collision point is shown in FIG. 6. In the case of a three dimension, the meaning of the direction of the normal vector of the collision point may be clear to those of ordinary skill in the art from FIG. 6 and the description of the present specification. However, in the present disclosure, the normal vector of the collision point may be defined in other ways besides the foregoing method to indicate a direction in which the collision can be avoided.

By moving the waypoint, that is, the coordinates where the industrial robot needs to pass through, in the direction of the normal vector, parts of the industrial robot, such as the end effector, which caused the collision do not overlap with the mesh of the obstacle. Therefore, it is possible to generate a trajectory in which no collision occurs by using the normal vector of the collision point as described in the present disclosure.

In one exemplary embodiment of the present disclosure, the movement direction of the waypoint may mean the direction of a mean normal vector computed based on the penetration depth of the collision point. The collision point in the simulation may be identified as the center point of the mesh where the collision occurred when the object is represented by a combination of polygonal meshes, such as triangles. When the collision point is identified in this way, the location of the collision point identified in the simulation may differ significantly from the location the actual collision occurred, especially when the polygons forming the mesh are large. In this case, the direction of the normal vector computed based on the identified collision point in the simulation may be different from the direction in which the waypoint needs to be moved to effectively eliminate the actual collision point. Thus, in one exemplary embodiment of the present disclosure, the movement direction of the waypoint may be determined based on a mean normal vector computed based on a penetration depth of the collision point. The processor 110 may compute the mean normal vector based on the penetration depth through Equation 1.

$$normal = \frac{{\sum }_{i = 0}^{n} \frac{1}{{depth}_{i}} \times norma {l}_{i}}{n} \qquad [ Equation 1 ]$$

Herein, normal is the mean normal vector computed based on the penetration depth, depth; is the penetration depth in each normal vector, and normal; is each normal vector. Computing the mean normal vector by the foregoing method may correct a distortion in the normal vector that may occur when a large mesh collides with a target.

In one exemplary embodiment of the present disclosure, the movement direction of the waypoint may mean a direction of one of a first normal vector computed based on the penetration depth of the collision point, a second normal vector computed based on the information about the plurality of collision points and the information about the mesh of collision points when the collision points are plural, and a third normal vector computed based on the first normal vector and the second normal vector. In the present disclosure, when multiple collisions occur and the direction of the normal vector is different at each collision point, all collisions cannot be resolved simultaneously by a method of moving the normal vector in one direction. In this case, a collision may be avoided by computing a plurality of normal vectors that have the possibility to avoid the collision, and using all of the plurality of normal vectors.

The processor 110 may obtain the average location of the plurality of collision points, compute a plane containing the average location and the center of gravity of each mesh where the collision occurred, and determine the normal vector of the corresponding plane as the second normal vector.

The processor 110 may compute a plane comprising the first normal vector and the second normal vector, and determine the normal vector of the corresponding plane as the third normal vector.

When the first normal vector, the second normal vector, and the third normal vector are computed as described above, the waypoint may be moved in the direction of the three normal vectors. For example, the direction of the first normal vector is indicated by A, the direction of the second normal vector is indicated by B, and the direction of the third normal vector is indicated by C, the processor 110 may move the waypoint by a method of moving the location of the end effector of the industrial robot 0.001 m in direction A, then moving the location of the end effector of the industrial robot 0.001 m in direction B, and then moving the location of the end effector of the industrial robot 0.001 m in direction C.

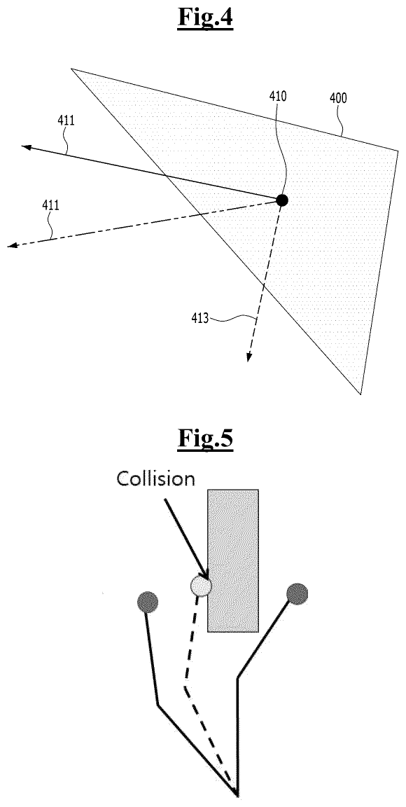

FIG. 4 is a conceptual diagram illustrating a normal vector according to the exemplary embodiment of the present disclosure. For each collision point 410 of the meshes 400 configuring an obstacle, the processor 110 may determine one of a first normal vector 411 computed based on the depth of penetration, a second normal vector 412 computed by averaging the plurality of collision points and based on a plane containing the center of gravity of each mesh in which a collision occurred, and a third normal vector 413 computed by a plane containing the first normal vector 411 and the second normal vector 412 as the movement direction of the waypoint.

In the present disclosure, the method of modifying a trajectory between working points is performed by a method of moving a waypoint by computing a normal vector of a collision point, but a trajectory between working points may be modified by inputting information about a collision point and information about a working point into a trajectory modification model, which is a reinforcement learning model. The trajectory modification model may be a pre-trained model based on the current trajectory as the state information, and a reward calculated based on a presence of a collision point, the length of the total working trajectory, and the total working time. A specific method of constructing the reinforcement learning model of the present disclosure will be described below with reference to FIG. 7.

FIG. 7 is a conceptual diagram illustrating a reinforcement learning model according to the exemplary embodiment of the present disclosure.

Reinforcement learning is a type of learning method that trains an artificial neural network model based on a reward calculated for an action selected by the artificial neural network model, so that the artificial neural network model is capable of determining a better action based on an input state. The reinforcement learning method may be understood as a “learning method through trial and error” in that decisions (that is, actions) are rewarded. In the reinforcement learning process, the reward given to the artificial neural network model may be the reward according to the accumulation of the results of multiple actions. Reinforcement learning generates an artificial neural network model that learns to maximize the reward itself or the return (the sum of the rewards) by considering different states and the reward for each action. In the present disclosure, the term “reinforcement learning model” may be used interchangeably with the term “agent” as an entity that determines an action. In the technical field of reinforcement learning, the term “environment” (Env) or “environment model” is used to refer to a “model that returns a result that takes into account the action of an agent”. An environment model may be a model that returns output data (for example, state information) for a given input data (for example, control information). An environment model may be a model structure for getting from input to output, or a model where the causal relationships between input and output data are unknown. The agent and the environment may operate by exchanging data.

In FIG. 7, the reinforcement learning model 310 is a subject that determines an action based on state information and rewards, and may be understood as an “agent”. In the present disclosure, the state information may include current state information and next state information. The current state information and the next state information may be distinguished according to the time or order in which the corresponding state information is obtained, and may be named as current state information (sₜ) and next state information (sₜ₊₁), respectively, based on the precedent relationship.

In the present disclosure, an environment 330 may yield “current state information (sₜ)” that may serve as a basis for the reinforcement learning model 310 to determine an action. After obtaining the current state information (sₜ) including at least one state variable from the environment 330, the processor 110 may input the current state information into the reinforcement learning model 310.

In the present disclosure, the processor 110 may input the current state information to the reinforcement learning model 310 and then calculate an action (Aₜ) based on the reinforcement learning model 310. The reinforcement learning model 310 may compute a probability distribution of a plurality of selectable actions based on the state information (sₜ) obtained from the environment 330 at any time t. The processor 110 may calculate an action (Aₜ) based on the computed probability distribution. For example, the processor 110 may determine the largest value in the probability distribution over the plurality of actions as the action (Aₜ).

In the present disclosure, the processor 110 may input the action calculated based on the reinforcement learning model 310 into the environment 330. The processor 110 may obtain updated next state information (sₜ₊₁) and a reward (Rₜ) from the environment 330 as a result of the input of the action. Reinforcement learning may be referred to as “model-based” reinforcement learning when the environment 330 knows the “reward function” on which the reward is based or the “transition probability distribution function” on which the environment 330 is based for determining the next state information after receiving the action from the reinforcement learning model 310. On the other hand, reinforcement learning when the reward function of the environment 330 and the transition probability distribution function of the environment 330 are unknown may be referred to as “model-free” reinforcement learning.

The reinforcement learning model according to the present disclosure may be trained based on at least one episode. In the present disclosure, the term “episode” may be used to mean a sequence of data having a sequence of order. An episode may be a dataset consisting of a plurality of N-tuples of data containing N elements (N is a natural number greater than or equal to 1). The plurality of N-tuple data contained in an episode may have a sequence. As an example of N-tuple data, if N is ‘4’, each 4-tuple data may contain current state information, action information, reward, and next state information as elements. As another example of N-tuple data, if N is ‘5’, each 5-tuple data may contain current state information, action information corresponding to the current state information, reward, next state information, and action information corresponding to the next state information as elements.

The processor 110 according to the present disclosure may obtain an episode by repeatedly performing a plurality of operations that are the same or similar to the exemplary embodiment of the learning method described above, from an initial state (t=0) to a terminal state (t=T). The terminal state may be derived when a predetermined termination condition is satisfied, or when a predetermined number of steps have been taken. The step refers to at least one unit of operation in which the reinforcement learning model receives a state, determines an action, and receives a reward or updated state information for the action. The preset number of steps may be set to any natural number, for example, 200 steps.

The processor 110 may train the reinforcement learning model based on the at least one training data. For example, at the end of each step, the processor 110 may train a reinforcement learning model based on the training data corresponding to each step. In another example, the processor 110 may train a reinforcement learning model based on a training dataset that includes training data for each of the plurality of steps at the end of each episode comprising the plurality of steps. In another example, the processor 110 may train a reinforcement learning model based on a training data set including training data for each of the steps after a predetermined batch size of steps has been performed. The batch size may be predetermined as any natural number.

The process of training the reinforcement learning model by the processor 110 according to the present disclosure may include an operation of modifying a respective node weight or deviation value of the neural network included in the reinforcement learning model. The operation of modifying the respective node weight or deviation value of the neural network included in the reinforcement learning model may be performed by the processor 110 in the same or similar manner as the backpropagation technique for the neural network described above with reference to FIG. 2. For example, when the reward (Rₜ) included in the training data (T_t) at a predetermined time t is a positive number, the processor 110 may adjust the weight or a deviation value of one or more nodes included in the reinforcement learning model such that the control action (Aₜ) included in the training data (T_t) is reinforced. In this case, the one or more nodes included in the reinforcement learning model may be nodes that were involved in determining the action (Aₜ) after the reinforcement learning model received the state information (sₜ) contained in the training data (T_t).

The trained reinforcement learning model 310 may determine an action for each state information such that the cumulative value of rewards (that is, returns) given from the environment 330 is maximized. The method of determining the action by the reinforcement learning model 310 may be based on at least one of, for example, a value-based behavior determination method, a policy-based behavior determination method, or a behavior determination method based on both values and policies. The value-based behavior determination method determines the behavior that gives the highest value in each state based on a value function. Examples of value-based behavioral decision methods include Q-learning and Deep Q-Network (DQN). The policy-based behavior determination method is a method of determining behavior based on a final return and policy function without a value function. Examples of policy-based behavior determination method include the policy gradient technique. The above action determination method based on both values and policies is a method that the reinforcement learning model determines the agent's action by learning in such a way that when the policy function determines the action, the value function evaluates the action. The action determination method based on both values and policies may include, for example, actor-critic algorithms, soft actor-critic algorithms, A2C algorithms, and A3C algorithms.

The foregoing specific descriptions for the training of the reinforcement learning model are for illustrative purposes only and do not limit the present disclosure.

Disclosed is a computer readable medium storing the data structure according to an exemplary embodiment of the present disclosure.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an availablely designed data structure, a computing device can perform operations while using the resources of the computing device to a minimum. Specifically, the computing device can increase the efficiency of operation, read, insert, delete, compare, exchange, and search through the availablely designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

In the present disclosure, a network function, an artificial neural network, and a neural network may be used to be exchangeable. From here on, it will be described uniformly using neural networks.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for training the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for training the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include training data input in a neural network training process and/or input data input to a neural network in which training is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network training process and/or a weight in which neural network training is completed. The weight which varies in the neural network training process may include a weight at a time when a training cycle starts and/or a weight that varies during the training cycle. The weight in which the neural network training is completed may include a weight in which the training cycle is completed. Accordingly, the data structure including the weight of the neural network may include a data structure including the weight which varies in the neural network training process and/or the weight in which neural network training is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of training cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

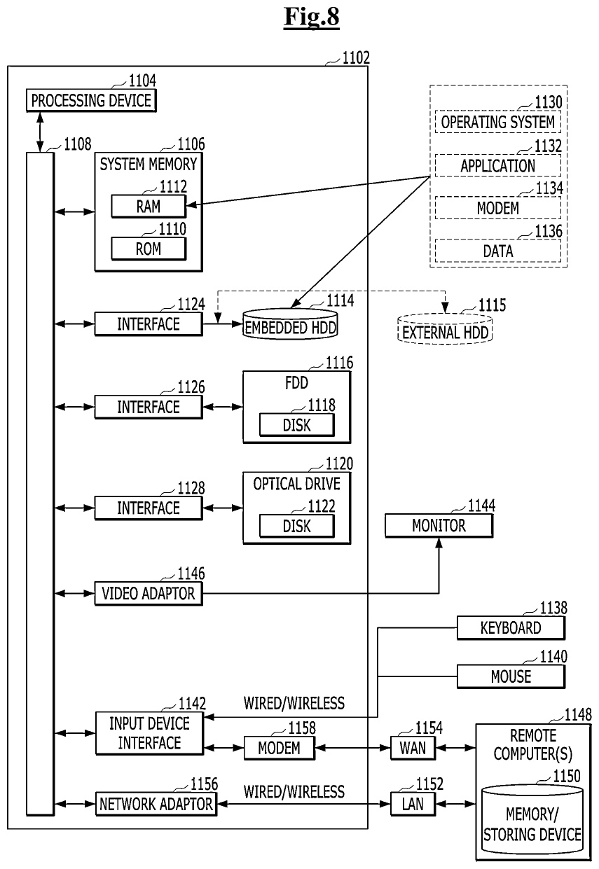

FIG. 8 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devicesas well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.
The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of anymedia among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure. Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

1. A method performed by a computing device to generate a working trajectory of an industrial robot, the method comprising:
identifying a plurality of working points for one or more industrial robots;
identifying a collision point based on a trajectory between the plurality of working points;
generating a waypoint based on information of the collision point;
determining a movement direction based on the information of the collision point;
moving the waypoint based on the movement direction;
modifying the trajectory between the working points to pass through the waypoint; and
generating a working trajectory of the industrial robot based on the modified trajectory between the working points;
wherein the movement direction includes a direction of a mean normal vector computed based on a penetration depth of the collision point.

2. (canceled)

3. (canceled)

4. (canceled)

5. The method of claim 1, wherein the movement direction includes at least one of direction of:
a first normal vector computed based on a penetration depth of the collision point;
a second normal vector computed based on information of a plurality of collision points and information of a mesh of the plurality of collision points, when the collision points are plural; or
a third normal vector computed based on the first normal vector and the second normal vector;
wherein the first normal vector computed based on the penetration depth of the collision point includes the mean normal vector computed based on the penetration depth of the collision point.

6. The method of claim 1, wherein the moving of the waypoint based on the movement direction includes:
moving a location of the waypoint within a threshold in the movement direction until the collision point disappears.

7. The method of claim 1, wherein the modifying of the trajectory between the working points based on the information of the collision point includes:
inputting information of the collision point and information of the working point into a trajectory modification model which is a reinforcement learning model; and
modifying the trajectory between the working points by using the trajectory modification model.

8. The method of claim 7, wherein the trajectory modification model is pre-trained based on a reward computed based on a presence of a collision point, a length of a total working trajectory, and a total working time.

9. A computer program stored in a non-transitory computer-readable storage medium, the computer program including instructions to cause a computing device to perform operations for generating a working trajectory of an industrial robot, the operations comprising:
an operation of identifying a plurality of working points for one or more industrial robots;
an operation of identifying a collision point based on a trajectory between adjacent working points among the plurality of working points;
an operation of generating a waypoint based on information of the collision point;
an operation of determining a movement direction based on the information of the collision point;
an operation of moving the waypoint based on the movement direction;
an operation of modifying the trajectory between the working points to pass through the waypoint; and
an operation of generating a working trajectory of the industrial robot based on the modified trajectory between the working points;
wherein the movement direction includes a direction of a mean normal vector computed based on a penetration depth of the collision point.

10. A computing device, comprising:
a processor including one or more cores;
a network unit; and
a memory,
wherein the processor is configured to:
identify a plurality of working points for one or more industrial robots, identify a collision point based on a trajectory between adjacent working points between the plurality of working points,
generate a waypoint based on information of the collision point,
determine a movement direction based on the information of the collision point,
move the waypoint based on the movement direction,
modify the trajectory between the working points to pass through the waypoint, and
generate a working trajectory of the industrial robot based on the modified trajectory between the working points,
wherein the movement direction includes a direction of a mean normal vector computed based on a penetration depth of the collision point.
